(19) United States
(12) Patent Application Publication
(10) Pub. No.: US 2024/0294259 A1
(43) Pub. Date: Sep. 5, 2024

(54) ENERGY ABSORBING MECHANISMS AND METHODS THEREOF

(71) Applicant: Supernal, LLC, Washington, DC (US)

(72) Inventors: Alexander POZZI, Carlsbad, CA (US); Noah GILSDORF, Atlanta, GA (US); Robert HENSHAW, Newnan, GA (US); Francis Garing, Atlanta, GA (US); Yahia Ismail, Seattle, WA (US); Ben Stephens, Winston-Salem, NC (US)

(73) Assignee: Supernal, LLC, Washington, DC (US)

(21) Appl. No.: 18/593,546

(22) Filed: Mar. 1, 2024

Related U.S. Application Data
(60) Provisional application No. 63/488,443, filed on Mar. 3, 2023.

(51) Int. Cl. B64D 11/06

(52) U.S. Cl. CPC B64D 11/0619

(57) ABSTRACT

A vehicle seat is provided. The vehicle seat may include: a seat leg having a base component and a rod component, wherein a first surface of the base component is attached to a floor of a vehicle and a second surface of the base component is attached to a first end of the rod component; an energy absorbing component associated with the rod component; and a seat bucket having a receiving component configured to house the energy absorbing component and the rod component. Other aspects are described and claimed.

### CROSS REFERENCE TO RELATED APPLICATIONS

This application claims priority to U.S. Provisional Application No. 63/488,443, filed Mar. 3, 2023, which is incorporated by reference herein in its entirety.

### TECHNICAL FIELD

Aspects of the present disclosure relate generally to various types of energy absorbing mechanisms and, more particularly, to energy absorbing components integrated within a seat of a vehicle that may mitigate the physical stress experienced by a seated occupant in the event of a vertical impact event.

### BACKGROUND

Over the past several decades, great effort has gone into the development of various components that may protect aircraft occupants during travel. Some of these components include padded instrument panels, fireproof seat cushions, lap belts, shoulder harnesses, and the like. Although the foregoing safety features may be effective in securing occupants in place during sudden horizontal and/or lateral decelerations, they have not proved to be sufficient when accidents occur resulting from large and/or rapid vertical decelerations. To address these issues, various types of energy-absorbing seats have been developed that are designed to absorb impact energy and reduce the resultant forces applied to passengers, thereby increasing occupant survival potential. Conventional energy-absorbing seats, however, are not perfect and improvements may be made with respect to seat weight, configuration, and effectiveness.

The present disclosure is accordingly directed to an improved energy-absorbing seat that may more efficiently decrease the load experienced by an occupant during a crash. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, energy-absorbing mechanisms are disclosed that are configured to minimize the effect of impact forces on an occupant during a vehicle impact event.

In one aspect, a vehicle seat is provided. The vehicle seat includes: a seat leg having a base component and a rod component, wherein a first surface of the base component is attached to a floor of a vehicle and a second surface of the base component is attached to a first end of the rod component; an energy absorbing component associated with the rod component; and a seat bucket having a receiving component configured to house the energy absorbing component and the rod component.

In another aspect, an energy absorbing seat of a vehicle is provided. The energy absorbing seat includes: a seat leg having a base component and a rod component, wherein a first surface of the base component is attached to a floor of the vehicle and a second surface of the base component is attached to a first end of the rod component; a seat bucket attached onto the second end of the rod component of the seat leg, wherein the seat bucket comprises a first component and a second component; wherein the first component comprises a folded area secured by one or more stitches; wherein the folded area is configured to rip upon experiencing a predetermined force load.

In yet another aspect, a method of decreasing a force of an impact event on a user in a vehicle seat of a vehicle is provided. The method includes: receiving, at a first component of the vehicle seat, a predetermined force load associated with the impact event, wherein the first component is a textile fabric comprising a folded area secured by one or more stitches; ripping, in response to the received predetermined force load, the one or more stitches of the folded area; freeing, responsive to the ripping, an additional portion of the textile fabric contained within the folded area; and lowering, based on the freeing, the first component a predetermined distance as dictated by the additional portion.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate the disclosed embodiments, and together with the description, serve to explain the principles of the disclosed embodiments. There are many aspects and embodiments described herein. Those of ordinary skill in the art will readily recognize that the features of a particular aspect or embodiment may be used in conjunction with the features of any or all of the other aspects or embodiments described in this disclosure. In the drawings:

FIG. 1 depicts an exploded view of an energy absorbing seat, according to one or more embodiments of the present disclosure.

FIGS. 2A and 2B depict components of the energy absorbing seat from FIG. 1 in a first configuration, according to one or more embodiments of the present disclosure.

FIGS. 3A and 3B depict components of the energy absorbing seat from FIG. 1 in a second configuration, according to one or more embodiments of the present disclosure.

FIGS. 4A-4C depict components of an energy absorbing mechanism, according to one or more embodiments of the present disclosure.

FIG. 5 depicts components of an energy absorbing mechanism in a first configuration, according to one or more embodiments of the present disclosure.

FIG. 6 depicts components of the energy absorbing mechanism in FIG. 5 in a second configuration, according to one or more embodiments of the present disclosure.

FIG. 7 depicts components of an energy absorbing mechanism in a first configuration, according to one or more embodiments of the present disclosure.

FIGS. 8A and 8B depict components of the energy absorbing mechanism in FIG. 7 in a second configuration, according to one or more embodiments of the present disclosure.

FIG. 9 depicts components of an energy absorbing mechanism in a first configuration, according to one or more embodiments of the present disclosure.

FIG. 10 depicts components of the energy absorbing mechanism in FIG. 9 in a second configuration, according to one or more embodiments of the present disclosure.

FIG. 11 depicts components of an energy absorbing mechanism in a first configuration, according to one or more embodiments of the present disclosure.

FIG. 12 depicts components of the energy absorbing mechanism in FIG. 11 in a second configuration, according to one or more embodiments of the present disclosure.

FIG. 13 depicts components of an energy absorbing mechanism in a first configuration, according to one or more embodiments of the present disclosure.

FIG. 14 depicts components of the energy absorbing mechanism in FIG. 13 in a second configuration, according to one or more embodiments of the present disclosure.

FIG. 15 depicts a first component of an energy absorbing mechanism, according to one or more embodiments of the present disclosure.

FIG. 16 depicts a second component in conjunction with the first component of an energy absorbing mechanism, according to one or more embodiments of the present disclosure.

FIGS. 17A and 17B depict components of an energy absorbing mechanism in a first configuration, according to one or more embodiments of the present disclosure.

FIG. 17C depicts components of the energy absorbing mechanism in FIGS. 17A and 17B in a second configuration, according to one or more embodiments of the present disclosure.

FIGS. 18A and 18B depict components of an energy absorbing mechanism, according to one or more embodiments of the present disclosure.

FIG. 19 depicts an energy absorbing seat, according to one or more embodiments of the present disclosure.

FIG. 20 depicts another view of the energy absorbing seat in FIG. 18, according to one or more embodiments of the present disclosure.

FIG. 21 depicts a cross section configuration of the energy absorbing seat in FIG. 19 in a first configuration, according to one or more embodiments of the present disclosure.

FIG. 22 depicts a cross section configuration of the energy absorbing seat in FIG. 19 in a second configuration, according to one or more embodiments of the present disclosure.

FIG. 23 depicts a graph illustrating a relationship of pressure on the stiffness and dampening properties of a vibration dampening material at various load frequencies, according to one or more embodiments of the present disclosure.

FIGS. 24A-24C depict various views of a first implementation of how a vibration dampening material may be integrated into a vehicle, according to one or more embodiments of the present disclosure.

FIG. 25 depicts a vehicle floor within which a vibration dampening material may be integrated, according to one or more embodiments of the present disclosure.

FIGS. 26A and 26B depict various views of a second implementation of how a vibration dampening material may be integrated into a vehicle, according to one or more embodiments of the present disclosure.

### DETAILED DESCRIPTION OF THE EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as “about,” “approximately,” “substantially,” and “generally,” are used to indicate a possible variation of ±10% of a stated or understood value. In addition, the term “between” used in describing ranges of values is intended to include the minimum and maximum values described herein. The use of the term “or” in the claims and specification is used to mean “and/or” unless explicitly indicated to refer to alternatives only or the alternatives are mutually exclusive, although the disclosure supports a definition that refers to only alternatives and “and/or.” As used herein “another” may mean at least a second or more.

As used herein, the term “vehicle” may refer to any type of vehicle, e.g., motor vehicles (e.g., cars, trucks, buses, etc.), railed vehicles (e.g., trains, etc.), amphibious vehicles (e.g., boats, etc.), aircraft (e.g., planes, helicopters, etc.), spacecraft, autonomous or semi-autonomous vehicles, and the like. Various embodiments of the present disclosure relate generally to electric vehicles, such as vehicles driven via one or more electric loads, components associated with the electrical loads, and monitoring systems for the electrical loads and/or the components associated with the electrical loads. The electric loads may be in the form of electric motors associated with one or more propellers of a vertical takeoff and landing vehicle.

Designers of vehicles have strived for many years to provide safety devices designed to protect the vehicle occupants from injury in the event of a mishap. During vehicle operation, the occupants (e.g., one or more vehicle operators, passengers, etc.) are generally seated within a vehicle compartment or cabin. Because the vehicle is generally in motion, external forces may cause the compartment to abruptly change its direction of motion, thereby resulting in forces exerted upon the occupant. If such forces are too great, the occupant may be seriously injured or killed.

Various safety features have been developed to protect the occupant from the foregoing types of forces. Seat belts, for instance, are a notable example of such a protection as they prevent the occupant from being thrown out of their seat and against the contents of the interior of the vehicle. However, seat belts are generally inelastic so that when the occupant is abruptly thrown against the seat belt, the force is absorbed by the human body. If the force is too great, then the human body may be unable to dissipate the force by its natural elasticity and damage to tissue or bones may occur. Additionally, seat belts do little to protect the occupant from vertical impact forces, such as those commonly experienced in airplane or helicopter accidents. Rather, these vertical forces have been conventionally addressed by the incorporation of cushions, springs, hydraulic shock absorbers, and/or other energy attenuation devices within the base of the occupant seat. However, these safeguards all have certain non-trivial and adverse weight and space effects that may detract from the utility of the vehicle, thereby requiring adverse design tradeoffs that may reduce vehicle efficiency.

Accordingly, a need exists for an improved energy absorption mechanism that may be incorporated into an occupant seat in a vehicle. More particularly, the energy absorption mechanism may be configured to attenuate impact forces on an occupant during a vehicle impact event all while being inexpensive to construct, low-weight, and comfortable to use by occupants during all normal operations without deforming.

Reference will now be made in detail to the exemplary embodiments of the present disclosure described below and illustrated in the accompanying drawings. Wherever possible, the same reference numbers will be used throughout the drawings to refer to same or like parts.

Additional objects and advantages of the embodiments will be set forth in part in the description that follows, and in part will be obvious from the description, or may be learned by practice of the embodiments. It is to be understood that both the foregoing general description and the following detailed description are exemplary and explanatory only and are not restrictive of the claims. For simplicity purposes, the vehicle in the remaining disclosure described herein, and the figures associated therewith, is an electric powered vertical take-off and landing (VTOL) aircraft. However, such a designation is not limiting and the concepts described herein may be applicable to virtually any type of vehicle.

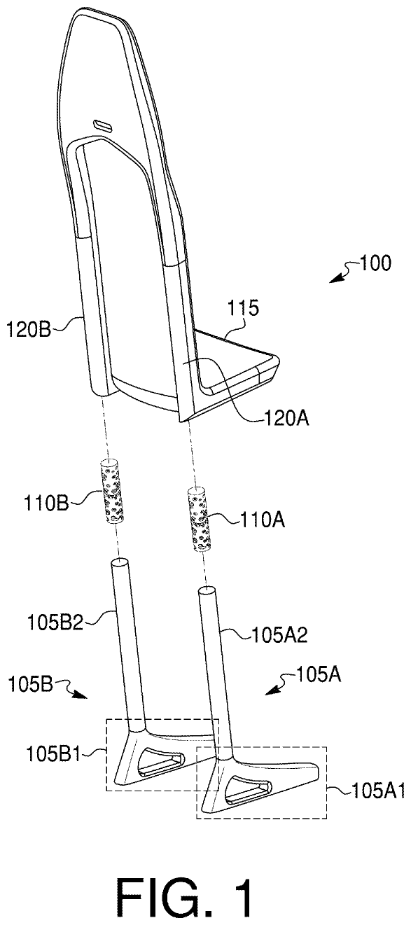

Referring now to FIG. 1, an exploded view of an exemplary vehicle seat 100 is provided. Vehicle seat 100 may contain seat legs 105A, 105B, foam components 110A, 100B, and seat bucket 115.

In an embodiment, each of seat legs 105A, 105B may be mounted to the cabin floor of a vehicle (not illustrated). More particularly, each of seat legs 105A, 105B may be composed of base components 105A1, 105B2 and rod components 105A2, 105B2, respectively. A first surface of each of base components 105A1, 105A2 may be attached or otherwise secured to the cabin floor and a second surface of each of base components 105A1, 105A2 may be connected to each of rod components 105A2, 105B2, as illustrated in FIG. 1. More particularly, in an embodiment, each of rod components 105A2, 105B2 may be cylindrical in shape and may contain a first end and a second end, wherein each of the first and second ends may be circular in shape. A first end of each of rod components 105A2, 105B2 may be connected to the second surfaces of each of the base components 105A1, 105B1. It is important to note that base components 105A1, 105B1 and rod components 105A2, 105B2 are not limited to the shapes and dimensions illustrated in FIG. 1. For instance, each of rod components 105A2, 105B2 may not be shaped as a cylinder, but rather, may be cuboid shaped.

In an embodiment, a second end of each of rod components 105A2, 105B2 may be positioned next to foam components 110A, 110B. The two foam components 110A, 100B may each be composed of the same material or, alternatively, may be composed of two different materials having similar properties. Although other foam-like materials may be utilized, for simplicity purposes the remaining disclosure is described herein with reference to aluminum as the primary material that composes each of the two foam components 110A, 110B. Properties of the aluminum foam enable its shape and structure to be compressed. More particularly, aluminum foam may be manufactured to have a threshold load before compression, thereby enabling the foam to compress in the event of a vertical impact event (i.e., a crash) but remain uncompressed upon occupant seating or upon experience other vertical forces (e.g., normal turbulence, etc.). Additionally, the utilization of the foam within the seat structure may diminish the weight of the seat itself.

In an embodiment, portions of each of rod components 105A2, 105B2, along with an entirety of each of foam components 110A, 110B, may be positioned within receiving components 120A, 120B of seat bucket 115. More particularly, vehicle seat 100 may contain a first side and a second side, wherein the second side is positioned opposite from the first side. The first side may contain seat bucket 115 and the second side may contain receiving components 120A, 120B. For instance, receiving components 120A, 120B may be integrated into a portion of a back rest of vehicle seat 100.

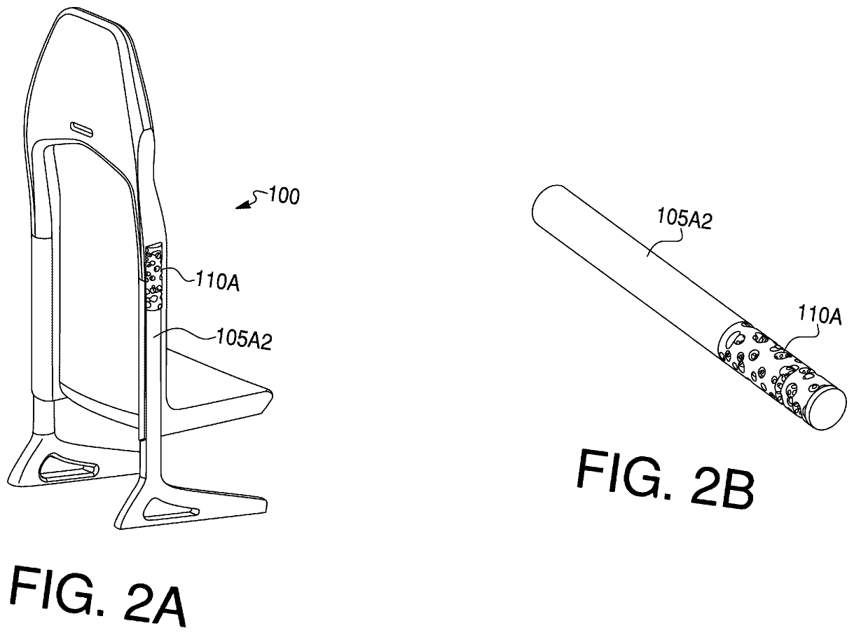

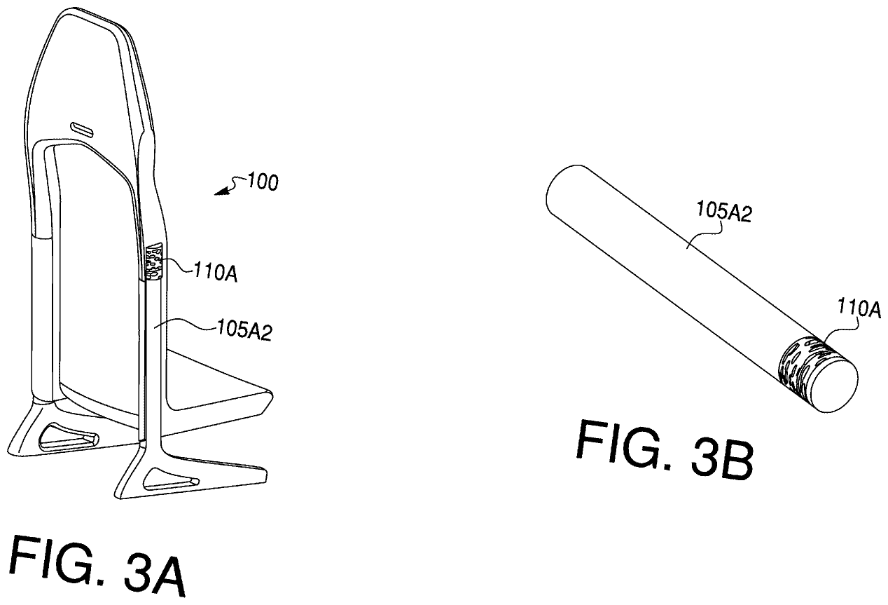

The collective components in the seating structure of vehicle seat 100 may act as an energy absorber to decrease the load that a seated occupant may experience during a vertical impact event (i.e., a crash). For instance, turning now to FIG. 2A, vehicle seat 100 from FIG. 1 is illustrated in a first configuration. The first configuration may be considered a “normal” configuration that vehicle seat 100 is in during normal, issue-free operation of the vehicle. FIG. 2B illustrates an exemplary state of rod component 105A2 and foam component 110A when vehicle seat 100 is in the first configuration. As illustrated, foam component 110A in the first configuration may be in an uncompressed state. Upon a vertical impact event, vehicle seat 100 may change from the first configuration to a second configuration, as illustrated in FIG. 3A. More particularly, seat bucket 115 may be forced downwards as a result of the impact event, thereby causing foam component 110A to be compressed against rod component 105A2 and changing it to a compressed state, as illustrated in FIG. 3B. The compression of foam component 110A may effectively diminish the impact forces felt by the seated occupant. Although not explicitly illustrated, the states of rod component 105B2 and foam component 110B may be substantially identical as rod component 105A2 and foam component 110A in the first configuration and the second configurations of the vehicle seat 100.

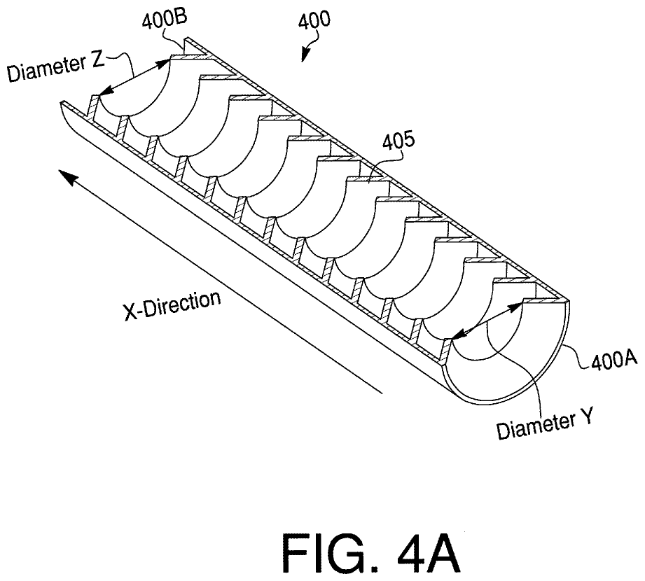

FIGS. 4-18 illustrate a variety of different configurations of the rod components of the seat legs illustrated in FIGS. 1-3. These configurations may provide similar or better energy attenuation as the foam components described above but in a simpler design, i.e., without the need for the foam components in the vehicle seat.

Referring now to FIGS. 4A-4C, an energy absorbing mechanism is illustrated according to an embodiment. With respect to FIG. 4A, a cross-section view of tube 400 is provided that includes plurality of fins 405. In an embodiment, tube 400 may be representative of receiving components 120A, 120B illustrated in FIGS. 1-3 or, alternatively, may be another component that is positioned within each of the receiving components 120A, 120B. Each of plurality of fins 405 may be, for example, circular in shape and may be integrated into an interior surface of tube 400. Additionally, each of plurality of fins 405 may protrude toward an interior center of the tube at a predetermined angle (e.g., a 45 degree angle, etc.). In an embodiment, plurality of fins 405 may gradually expand in size along an X-directional length of tube 400. The resultant consequence is that the diameter of the interior cavity formed by plurality of fins 405 may gradually decrease along the X-directional length. Accordingly, Diameter Y of a hollow formed by a fin positioned closest to first end 400A of tube 400 may be larger than Diameter Z of a hollow formed by another fin positioned closest to a second end 400B of tube 400, positioned opposite the first end 400A.

FIGS. 4B-4C provide cross-sectional views of tube 400 containing rod component 410. As mentioned, rod component 410 may be a portion of the seat legs of a vehicle seat, as illustrated in FIG. 1. In a first configuration (i.e., during normal operation and motion of the vehicle), a portion of rod component 410 may be positioned within tube 400. In this regard, the diameter of rod component 410 may be substantially consistent throughout and may be smaller than the diameter of at least the interior cavity formed by the fin closest to first end 400A (i.e., Diameter Y as illustrated in FIG. 4A). Accordingly, rod component 410 may be inserted into tube 400 at first end 400A and may be inserted into the interior cavity of tube 400 formed by plurality of fins 405 up to a predetermined insertion depth, i.e., the depth at which the diameter of the interior cavity is substantially similar to the diameter of the rod component 410 . . . . During normal operation, rod component 410 may remain at the predetermined insertion depth and may be configured to support a seated individual. During a vertical impact event, the energy absorption mechanism may transition to a second configuration in which tube 400 may be forced to translate down around rod component 410, e.g., along the X-direction. Because the diameter of rod component 410 is larger than the diameter of the interior cavities formed by the fins positioned closer to second end 400B of tube 400, the fins proximate to second end 400B may sheer against the side of rod component 410, thereby gradually impeding further translation of tube 400 around rod component 410. This controlled stroking of seat bucket 115 may provide an attenuating force, which may diminish the forces felt by the occupant.

It is important to note that the shape of tube 400 and shapes of plurality of fins 405 illustrated in FIG. 4A are not limiting and tube 400 and plurality of fins 405 may adopt different shapes while still achieving the same functional purpose. In an aspect, each of plurality of fins 405 may be similarly shaped, as illustrated in FIGS. 4A-4C, or, alternatively, a subset of plurality of fins 405 may be differently shaped than the rest of plurality of fins 405.

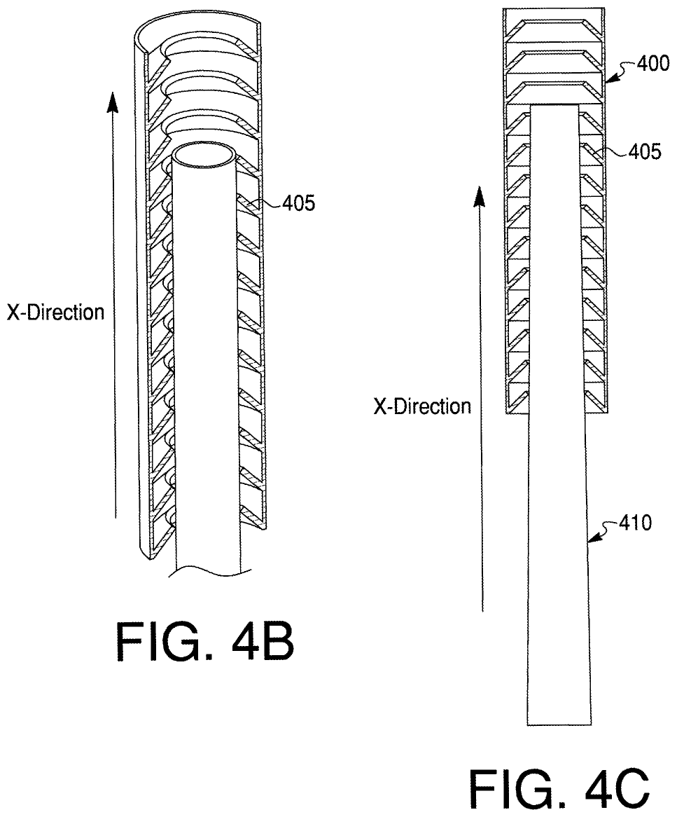

Referring now to FIG. 5, another energy absorption mechanism 500 is illustrated according to an embodiment. Energy absorption mechanism 500 may be contained within one or both of receiving components 120A, 120B of seat bucket 115 and may be composed of tube 505 and rod component 510. In an embodiment, tube 505 may be substantially circular in shape and may be secured in place within receiving components 120A, 120B of seat bucket 115. In some embodiments, tube 505 may be composed of first portion 505A that is connected to second portion 505B. In some embodiments, the outer edge of second portion 505B may be attached to/integrated with an inner surface of receiving components 120A, 120B. Each of first portion 505A and second portion 505B may be cylindrically shaped and may contain an interior cavity. In some embodiments, the interior cavity in each of first and second portions 505A, 505B may have the same dimensions. In some embodiments, bases of second portion 505B may have a greater diameter than bases of first portion 505A.

Tube 505 may further contain a first and second opening through which first end 510A of rod component 510 may be inserted. In an embodiment, tube 505 may contain one or more integrated chisels 515 that may be embedded within a pre-notched groove 520 of rod component 510. Pre-notched groove 520 may be machined into rod component 510 proximate to first end 510A of rod component 510. In an embodiment, pre-notched groove 520 may extend around an entire circumference of rod component 510, as illustrated in FIG. 5. In another embodiment, rod component 510 may contain a plurality of pre-notched grooves, each positioned on the same plane around a circumference of rod component 510. In such a configuration, each pre-notched groove may be configured to receive one chisel 515.

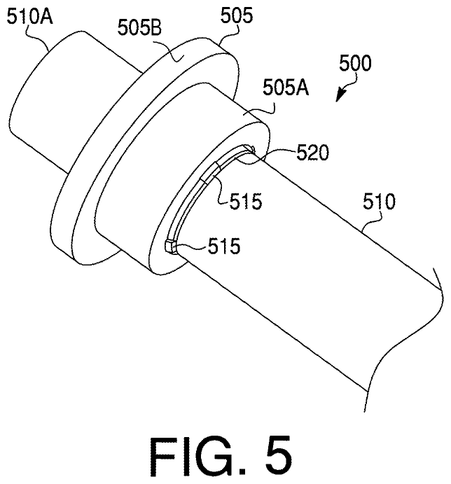

In a first configuration (i.e., during normal operation and motion of the vehicle), energy absorption mechanism 500 may be configured to sit as illustrated in FIG. 5, i.e., with tube 505 attached to rod component 510 via the chisel(s) 515 resting in pre-notched groove 520. Upon a vertical impact event of the vehicle, energy absorption mechanism 500 may transition from the first configuration, e.g., as represented in FIG. 5, to a second configuration, as illustrated in FIG. 6. More particularly, the forces of the impact may cause tube 505 (and correspondingly the occupant seat) to move vertically down rod component 510, longitudinally delaminating portions of rod component 510 that correspond to the chisel locations. The delamination of rod component 510 by chisel(s) 515 may counteract the impact forces by causing seat bucket 115 to gradually stroke down, thereby diminishing the extent of forces felt by a seated occupant.

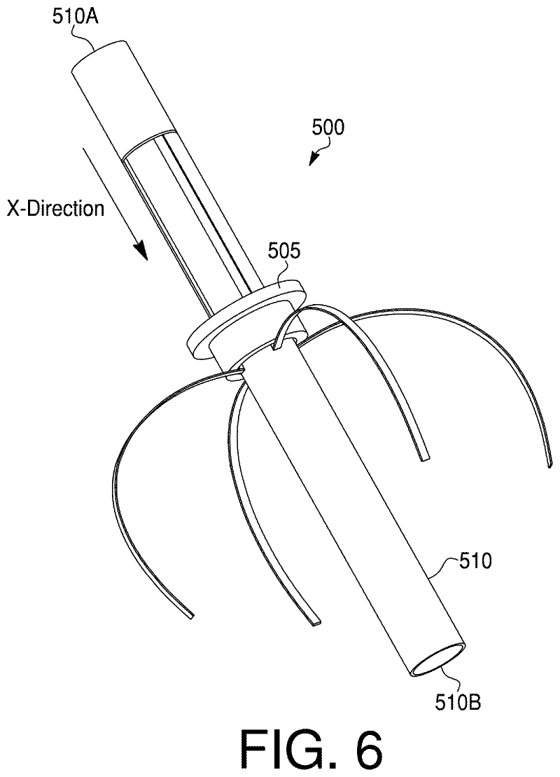

Referring now to FIG. 7, another energy absorption mechanism 700 is illustrated according to an embodiment. Energy absorption mechanism 700 may be contained within one or both of receiving components 120A, 120B of seat bucket 115 and may be composed of compression die 705 and rod component 710. In an embodiment, compression die 705 may be substantially circular in shape and may be secured in place within receiving components 120A, 120B of seat bucket 115 (e.g., via molding). In some embodiments, compression die 705 may be composed of first portion 705A that is connected to second portion 705B. In some embodiments, the outer edge of second portion 705B may be attached to/integrated with an inner surface of receiving components 120A, 120B. Each of first portion 705A and second portion 705B may be cylindrically shaped. In some embodiments, bases of second portion 705B may have a greater diameter than bases of first portion 705A.

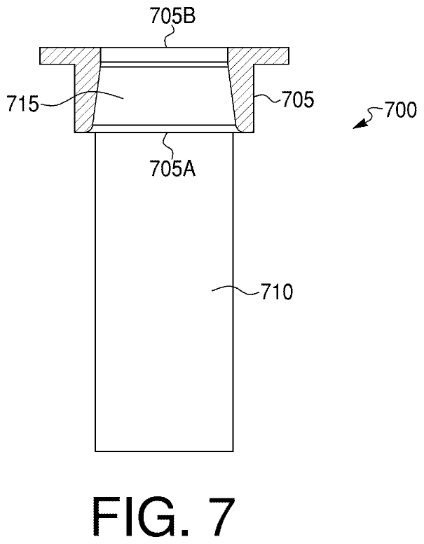

Compression die 705 may contain an interior cavity (not illustrated) that spans the length of compression die 705 from first opening 705A to second opening 705B. In an embodiment, the interior cavity of compression die 705 may be configured to taper so that a diameter of interior cavity is gradually reduced from first opening 705A to second opening 705B. In a first configuration (i.e., during normal operation and motion of the vehicle), a portion of rod component 710 may be positioned within the interior cavity of compression die 705 (e.g., up to the point where the diameter of the inner cavity is less than the diameter of rod component 710). Upon a vertical impact event of the vehicle, energy absorption mechanism 700 may transition from the first configuration, e.g., as illustrated in FIG. 7, to a second configuration, e.g., as illustrated in FIGS. 8A and 8B. More particularly, the forces of the impact may cause compression die 705 to move vertically down rod component 710, compressing the portions of rod component 705 that it passes over. This forced compression of rod component 705 by tapered interior cavity of compression die 710 may counteract and diminish the impact forces felt by a seat occupant.

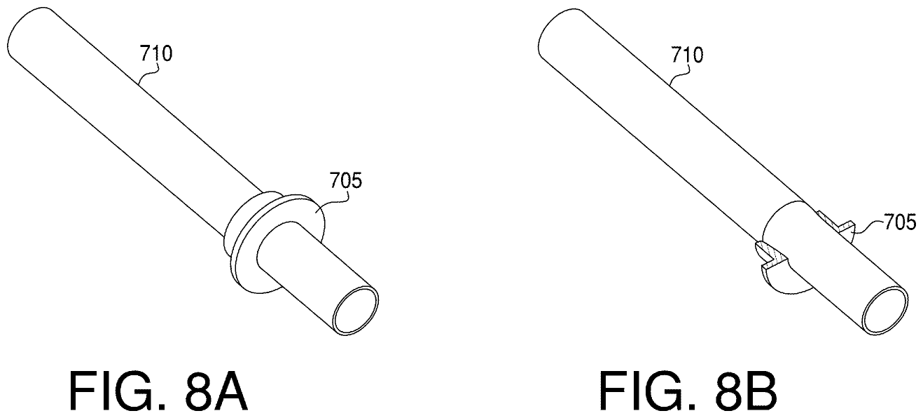

Referring now to FIG. 9, another energy absorption mechanism 900 is illustrated according to an embodiment. Energy absorption mechanism 900 may be contained/integrated within one or both of receiving components 120A, 120B of seat bucket 115 and may be composed of shape-changing die 905 and rod component 910. Shape-changing die 905 may contain an interior cavity (not illustrated), first opening 905A, and second opening 910B. In an embodiment, first opening 905A may be a different shape than second opening 905B. For instance, first opening 905A may be circular whereas second opening 905B may be rectangular. It is important to note that these designations are not limiting and that first opening and/or second opening may be configured to have a different shape.

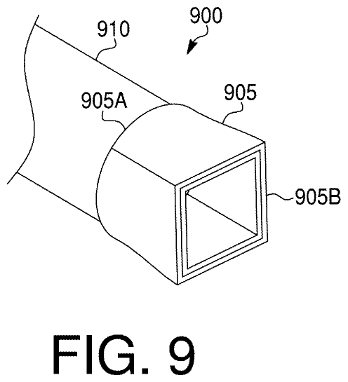

In a first configuration (i.e., during normal operation and motion of the vehicle), a portion of rod component 910 may be positioned at least partially within shape-changing die 905 via entrance through whichever of openings, 905A or 905B, has the most similar shape as rod component 910. For instance, if rod component 910 is cylindrical in shape with circular-shaped ends, then rod component 910 may enter shape-changing die 905 at first opening 905A, which is also circular-shaped. Upon a vertical impact event of the vehicle, energy absorption mechanism 900 may transition from the first configuration, e.g., as illustrated in FIG. 9, to a second configuration, e.g., as illustrated in FIG. 10. More particularly, the forces of the impact may cause shape-changing die 915 to move vertically down rod component 910, changing the shape of portions of rod component 910 that it passes over. For instance, rod component 910 in FIG. 10 may originally be cylindrically-shaped but may deform into a cuboid-shaped rod upon exit from the rectangular-shaped second opening 905B of shape-changing die 905. This forced deformation of rod component 910 from one shape into another shape may provide enough energy attenuation to decrease the stresses experienced by a seated occupant.

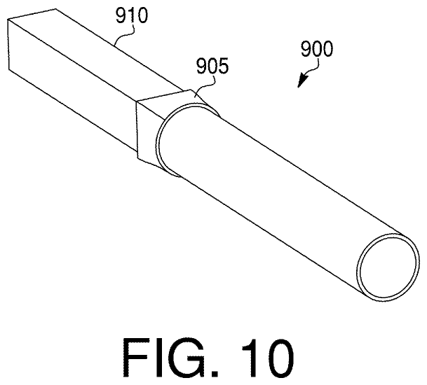

Referring now to FIG. 11, another energy absorption mechanism 1100 is illustrated according to an embodiment. Energy absorption mechanism 1100 may be contained and/or molded within one or both of the receiving components 120A, 120B of seat bucket 115 and may be composed of stepped die 1105 and rod component 1110. Stepped die 1105 may contain multiple “steps” 1115A, 1115B, or ridges, that may allow for different maximum loads during the stroke path. More particularly, each step 1115a, 1115B may progressively reduce the diameter of an internal cavity of stepped die 1105, thereby requiring rod component 1105, which may have a greater diameter than the diameter of the internal cavity formed by first step 1115A, to progressively deform to pass through (i.e., the diameter of rod component 1105 may be reduced as it progresses through stepped die 1105).

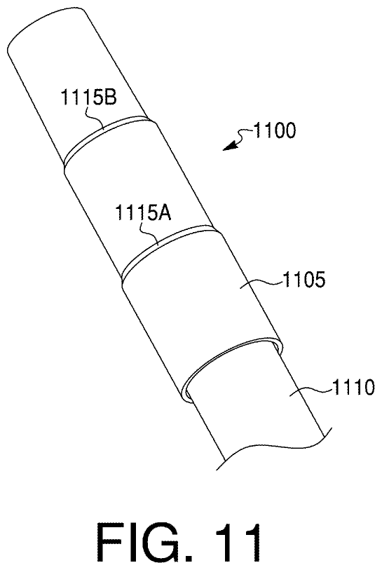

In a first configuration (i.e., during normal operation and motion of the vehicle), a portion of rod component 1110 may be positioned at least partially within stepped die 1105. More particularly, rod component 1110 may be positioned up against first step 1115A of stepped die 1105, at which point the diameter of an internal cavity of stepped die 1105 may be smaller than the diameter of rod component 1110. Upon a vertical impact event of the vehicle, energy absorption mechanism 1100 may transition from the first configuration, e.g., as illustrated in FIG. 11, to a second configuration, e.g., as illustrated in the cross-sectional view in FIG. 12. More particularly, the forces of the impact may cause stepped die 1105 to move vertically down rod component 1110, thereby progressively deforming rod component 1110 by reducing its diameter as it passes through each step. This forced diameter reduction of rod component 1110, against and through progressively smaller stepped barriers, may provide enough energy attenuation to decrease the stresses experienced by a seated occupant.

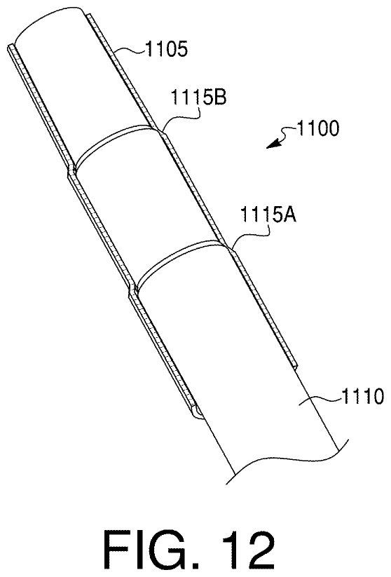

Referring now to FIG. 13, another energy absorption mechanism 1300 is illustrated according to an embodiment. Energy absorption mechanism 1300 may be contained and/or molded within one or both of receiving components 120A, 120B of seat bucket 115 and may be composed of expansion die 1305 and rod component 1310. Central body 1305A of expansion die 1305 may be substantially cylindrically-shaped and may be bookended by first end 1305B and second end 1305C. In some embodiments, outer edge of second end 1305C may be attached to/integrated with an inner surface of receiving components 120A, 120B. In an embodiment, the diameter of central body 1305A may be greater than the diameter of an internal cavity of rod component 1310. In an embodiment, first end 1305B of expansion die 1305 may be shaped as a half-sphere, thereby facilitating entry into the inner cavity of rod compartment 1310, as further described below.

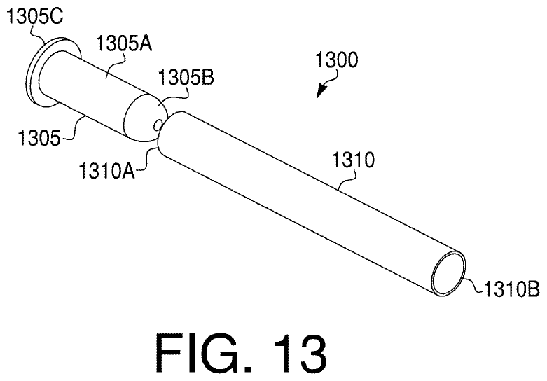

In a first configuration (i.e., during normal operation and motion of the vehicle), first end 1310A of rod component 1310 may be positioned or aligned against first end 1305B of expansion die 1305. Upon a vertical impact event of the vehicle, energy absorption mechanism 1300 may transition from the first configuration, e.g., as illustrated in FIG. 13, to a second configuration, e.g., as illustrated in FIG. 14. More particularly, the forces of the impact may cause expansion die 1305 to move vertically downwards, thereby enabling expansion die 1305 to enter into the internal cavity of rod component 1310. In an embodiment, expansion die 1305 may be forced into the rod component 1310 a predefined distance that may be based, for instance, upon a length of body 1305A of expansion die 1305. In an embodiment, because a diameter of body 1305A of expansion die 1305 is greater than a diameter of the internal cavity of rod component 1300, the internal cavity is forced to deform and expand as expansion die 1305 enters therein. Such a deformation process may provide enough energy attenuation to decrease the stresses experienced by a seated occupant.

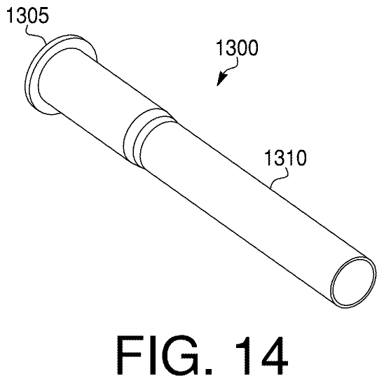

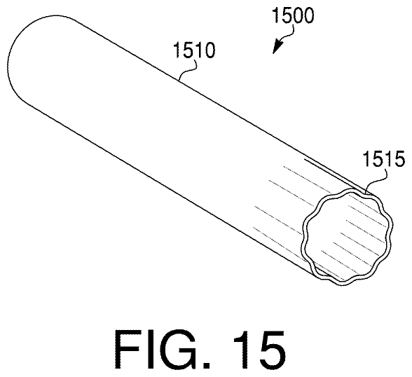

Referring now collectively to FIGS. 15-16, another energy absorption mechanism 1500 is illustrated according to an embodiment. Energy absorption mechanism 1500 may utilize the same principles of energy absorption mechanism 1300 described above with reference to FIGS. 13 and 14. In this regard, energy absorption mechanism 1500 may be contained and/or molded within one or both of the receiving components 120A, 120B of seat bucket 115 and may be composed of an expansion die 1505 configured to enter into an internal cavity of rod component 1510 upon a vertical impact event. Central body 1505A of expansion die 1505 may be substantially cylindrically-shaped and may be bookended by first end 1505B and second end 1505C. In some embodiments, outer edge of second end 1505C may be attached to/integrated with an inner surface of receiving components 120A, 120B. In an embodiment, rod component 1510 in energy absorption mechanism 1500 may not be perfectly shaped as a cylinder, but rather, may contain peripheral ridges and grooves, as indicated at 1515. These ridges and grooves may be configured to expand into a circle shape upon entry of expansion die 1505 into rod component 1510 (i.e., during transition from a first configuration to a second configuration) and may provide additional stability to rod component 1510 (i.e., so that it does not shatter upon entry of expansion die 1505). Accordingly, expansion die 1505 in this embodiment may act as a shape-changing expansion die by deforming/expanding the shape of rod component 1510 into a circle. This shape change result may provide additional energy absorption to the energy attenuation associated with energy absorption mechanism 1300. It is important to note that the starting shape of rod component 1510 illustrated in FIGS. 15 and 16 is non-limiting and other starting shapes may be utilized.

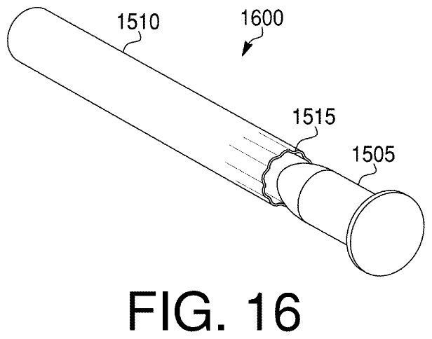

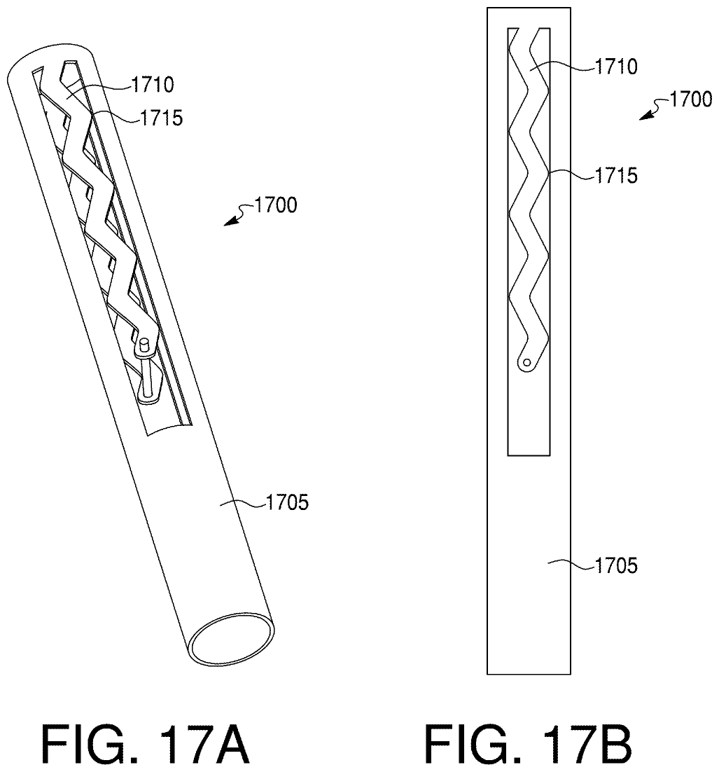

Referring now collectively to FIGS. 17A-17C, another energy absorption mechanism 1700 is illustrated according to an embodiment. Unlike the previous energy absorption mechanisms illustrated in FIGS. 1-16, energy absorption mechanism 1700 may not require the use of an additional component (e.g., a foam component, a tube component, a die component, etc.) to achieve energy attenuation. Rather, energy absorption mechanism 1700 may consist primarily of rod component 1705 that is manufactured to contain one or more zig-zag shaped section 1710 along at least a portion of its length. Zig-zag shaped section 1710 may contain edges 1715 that contact the surrounding walls of rod component 1710.

FIGS. 17A and 17B each illustrate energy absorption mechanism 1700 in a first configuration (i.e., during normal operation and motion of the vehicle). In this first configuration, seat bucket 115 may be locked from moving in both directions, thereby providing additional stability and comfort to the seated occupant. Upon a vertical impact event of the vehicle, energy absorption mechanism 1700 may transition from the first configuration, e.g., illustrated in FIGS. 17A and 17B, to a second configuration, e.g., as illustrated in FIG. 17C. More particularly, the forces of the impact may cause the zig-zag shaped section 1710 to stretch and permanently deform while stroking. During this stretching and straightening action, edges 1715 of zig-zag shaped section 1710 may sheer against the walls of rod component 1705, thereby providing energy attenuation to decrease the impact force felt by the seated occupant.

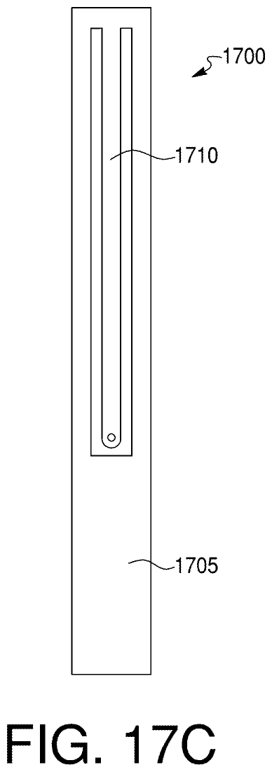

Referring now collectively to FIGS. 18A and 18B, another energy absorption mechanism 1800 is illustrated according to an embodiment. Similar to energy absorption mechanism 1700, energy absorption mechanism 1800 may be composed of a single component, e.g., rod component 1805, that is manufactured to contained a patterned section 1810. Patterned section 1810 may be cut or formed into rod component 1805 and may establish a prescribed “crush zone” and stroke length that rod component 1805 may deform during a vertical impact event. Accordingly, in a first configuration (i.e., during normal operation and motion of the vehicle), energy absorption mechanism 1800 may appear as illustrated in FIGS. 18A and 18B with the patterned section 1810 intact. Upon a vertical impact event of the vehicle, energy absorption mechanism 1800 may transition from the first configuration to a second configuration (not illustrated) in which patterned section 1810 may be caused to crush and collapse as a result of the downward movement of seat bucket 115, thereby providing energy attenuation to decrease the impact force felt by the seated occupant.

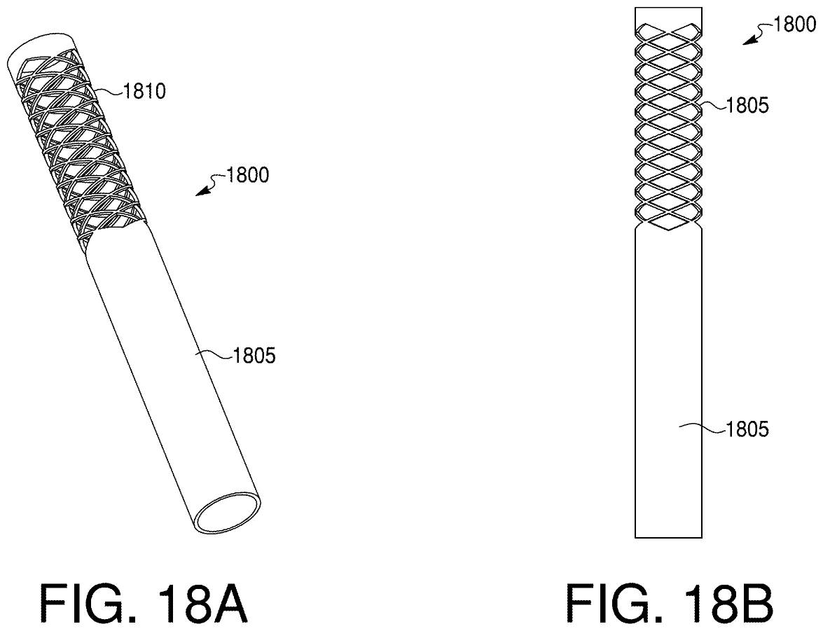

FIGS. 19-22 illustrate various aspects and views of an energy absorbing seat that may be configured to deform and provide energy attenuation during a vertical impact event of a vehicle.

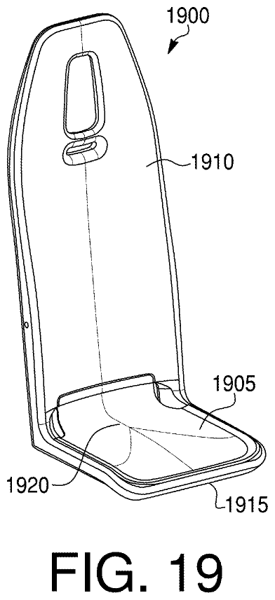

Turning now to FIG. 19, energy absorbing seat 1900 is illustrated according to an embodiment. Energy absorbing seat 1900 may contain first component 1905 and second component 1910. First component 1905 may correspond to the seating area where an occupant sits and second component 1910 may correspond to a vertical support against which the back of occupant rests when they are seated. In an embodiment, first component 1905 may be composed of a textile fabric seat pan that is stretched across frame 1915 of first component 1905 to support the seated occupant. The textile may be folded in on itself in one or more folded areas 1920 and subsequently sewn together with a thread and stitch pattern that is configured to rip at a specific load (e.g., in the event of a crash). This tearing action may effectively decrease the load experienced by the occupant. Additionally, the utilization of a fabric as opposed to another solid component for the seat pan may decrease the weight, complexity, and overall cost of energy-absorbing seat 1900. FIG. 20 provides an underside view of the energy absorbing seat 1900 containing the folded extra fabric 1925.

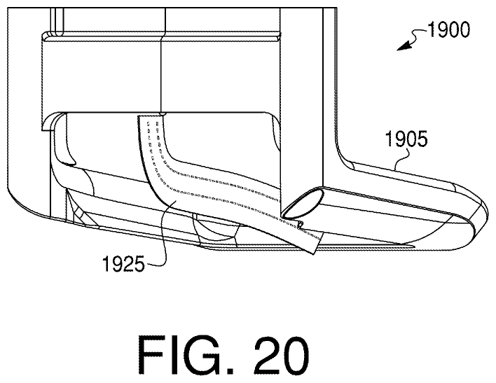

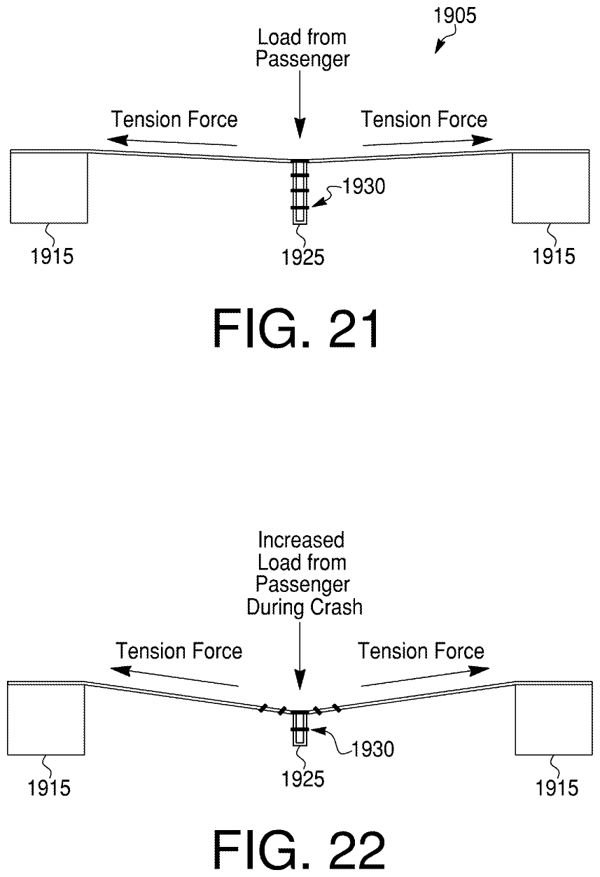

In a first configuration (i.e., during normal operation and motion of the vehicle), energy absorbing seat 1900 may appear as illustrated in FIGS. 19 and 20, with first component 1905 intact and containing folded areas 1920. An alternative view of energy absorbing seat 1900 in the first configuration is provided in FIG. 21. In this view, folded extra fabric 1925 and stitches 1930 in folded areas 1920 may be better visualized. In the event of a vertical impact event of the vehicle, energy absorbing seat 1900 may be configured to transition from the first configuration to a second configuration, as illustrated in FIG. 22. More particularly, in the event of a crash, the fabric of first component 1905 acts as a diaphragm that rips apart to absorb energy from the seated occupant. In this regard, a series of stitches 1930 may tear away and act as an energy absorber. Because the textile is folded in on itself, and then stitched, it will eventually bottom out and the occupant will not fall all the way through energy absorbing seat 1900.

In an embodiment, various adjustments may be made to the characteristics of first component 1905 to improve or adjust its energy attenuation properties based upon different needs and/or available resources. For example, first component 1905 may contain more than one folded area 1920. In another example, the type of stitching, the thickness of the thread, and/or the directionality of the stitching in the layers may be adjusted to change the rip potential of folded area 1920. In yet another example, a single folded area 1920 may contain two or more nested folded regions. In an embodiment, each of these nested folded regions may have the same or different stitching pattern as the others (e.g., the first nested folded region may contain more stitching than one or more other nested folded regions, etc.).

The illustrated shapes and features of the energy absorption mechanisms described above are exemplary and are not intended to limit their functional scope or design potential. In an embodiment, one or more features of any of the energy absorption mechanisms described above may be combined together to form different types of energy absorption mechanisms that are not elaborated upon here. For instance, the stepped die 1100 illustrated in FIG. 11 may contain a circular shaped first opening but a rectangular-shaped second opening, as utilized by the shape-changing die 900 in FIG. 9, in order to provide another load-bearing “step” for the rod component 1110 upon exit from the stepped die 1100. Additionally or alternatively, the energy absorbing seat 1900 illustrated in FIGS. 19-22 may be used in conjunction with any of the energy absorbing mechanisms illustrated in FIGS. 1-18. In such a situation, the combined energy attenuation properties of the energy absorbing seat 1900 and the energy absorption mechanism may collectively work to decrease the impact forces experienced by a seated occupant.

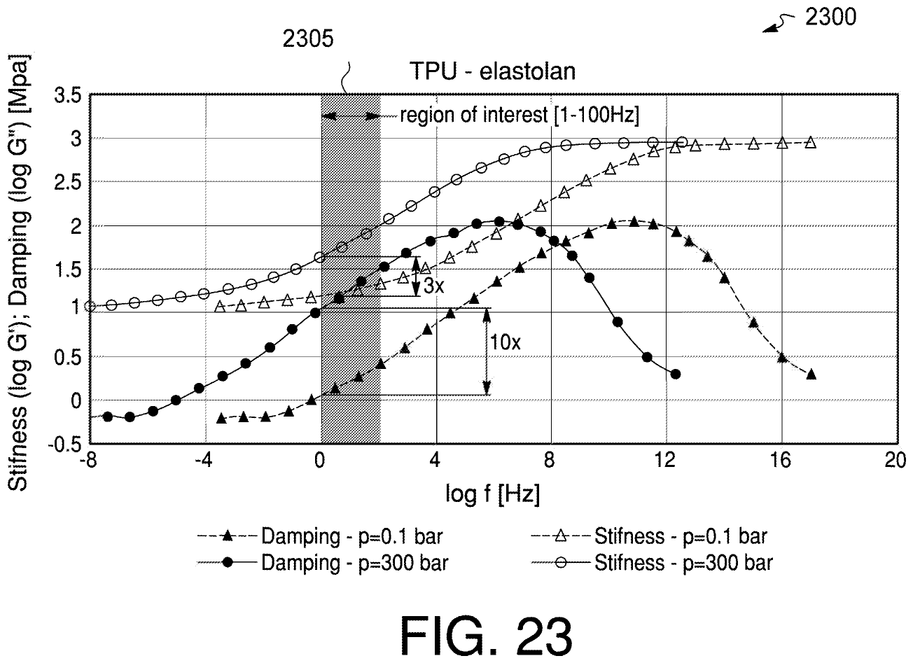

FIGS. 23-26(A-B) illustrate various exemplary uses cases of how a vibration dampening material may be implemented in a vehicle to reduce vibrations felt by occupants of the vehicle during its operation. More particularly, the vibration dampening material may be configured to reduce vibrations produced by the vehicle (e.g., from rotors in the case of aircraft) and/or from external sources (e.g., turbulence caused by existing weather) so that these forces do not have adverse effects on the ability of a pilot to operate the vehicle or cause discomfort to the passengers. In an embodiment, the vibration dampening material may be a pressurized viscoelastic material (e.g., an amorphous polymer, semicrystalline polymer, biopolymer, etc.). The vibration dampening material may be incorporated into various parts of the vehicle, as further described below.

FIG. 23 provides graph 2300 that illustrates the influence of pressure on the stiffness and dampening properties of a vibration dampening material depending on the load frequency. In an embodiment, the vibration dampening material may be a thermoplastic polyurethane (TPU) material. The TPU material may contain a certain inherent degree of viscoelasticity and may have: high wear and abrasion resistance, high tensile and tear strength, high resistance against oils, grease, oxygen, and ozone, good low-temperature flexibility, and/or good damping capacity. For a first pressure (e.g., 0.1 bar), graph 2300 illustrates that the TPU material achieves maximum damping potential at approximately 2 megapascals (Mpa) and maximum stiffness at approximately 3 Mpa when the load frequency is approximately 11 hertz (Hz) and 16 Hz, respectively. For a second pressure (e.g., 300 bar), graph 2300 illustrates that the TPU material achieves maximum damping potential at approximately 2 Mpa and maximum stiffness at approximately 3 Mpa when the load frequency is approximately 6 hertz Hz and 12 Hz, respectively. In a defined region of interest 2305, which may correspond to the load frequency range experienced by a vehicle during operation (e.g., 0-2 Hz), the damping and stiffness range of the TPU material held at 0.1 bar may be approximately 0-0.5 Mpa and approximately 1.1-1.3 MPA, respectively. Furthermore, in the defined region of interest 2305, the damping and stiffness range of the TPU material held at 300 bar may be approximately 1-1.5 Mpa and approximately 1.6-2 MPA, respectively.

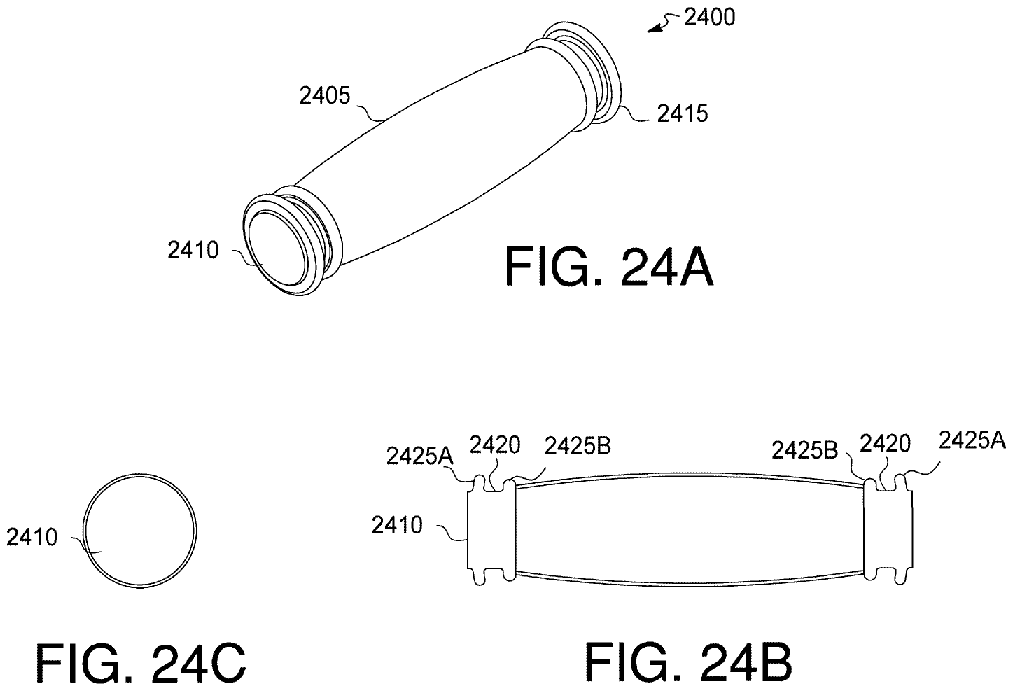

FIGS. 24(A-C) and 25 illustrate one exemplary implementation of how the vibration dampening material may be integrated into a vehicle to dissipate vibrations. In an embodiment, the vibration dampening material may be manufactured into a predetermined shape and may be inserted into the floor panels of a vehicle. For instance, FIG. 24A illustrates a perspective view of the vibration dampening material that is formed into a woven fiber tube 2400. FIGS. 24A and 24B present a front view and top view of woven fiber tube 2400. In an embodiment, central portion 2405A woven fiber tube 2400 may be substantially cylindrically shaped and may be bookended by first and second fiber tube plug 2410, 2415. First and second fiber tube plug 2410, 2415 may be composed of a polyethylene material and may be configured to maintain the shape of the dampening material.

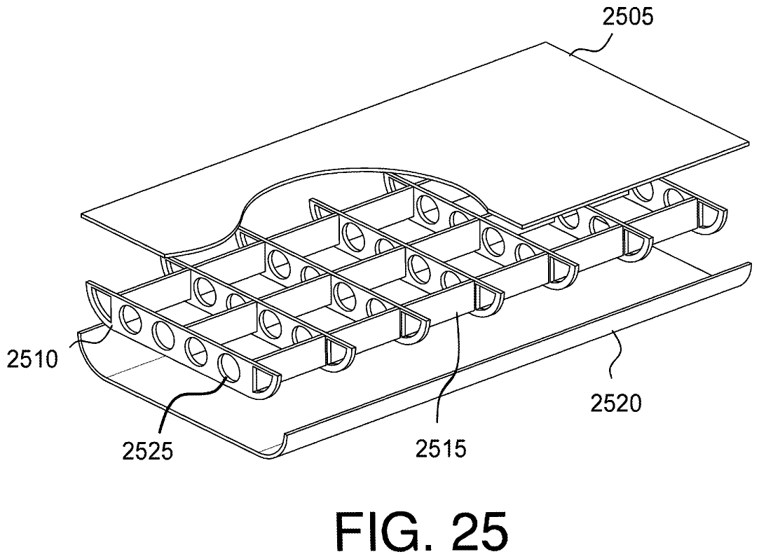

In an embodiment, each woven fiber tube 2400 may be inserted into the floor panels of a vehicle. For example, FIG. 25 illustrates an aircraft cabin floor 2505, a transverse bulkhead 2510, a keel beam 2515, and a lower fuselage skin 2520. Each transverse bulkhead 2510 may contain a plurality of holes 2525 that each woven fiber tube 2400 may be inserted into and through. In an embodiment, each of first and second fiber tube plug 2410, 2415 may contain a valley portion 2420 that is bookended by raised portions 2425A, 2425B. These shaped areas of first and second fiber tube plug 2410, 2415 may be configured to attach to portions of transverse bulkhead 2410 around each of the plurality of holes 2525 to enable woven fiber tube 2400 to be secured in place.

It is important to note that although the foregoing embodiments pertaining to the dampening material have been described with implementation into a vehicle floor, such designations are not limiting. More particularly, the dampening material may be incorporated into other aspects of the vehicle (e.g., within vehicle walls, within vehicle doors, other parts of the vehicle, etc.). Additionally, in some implementations, the vehicle floor itself may be composed of the vibration dampening material.

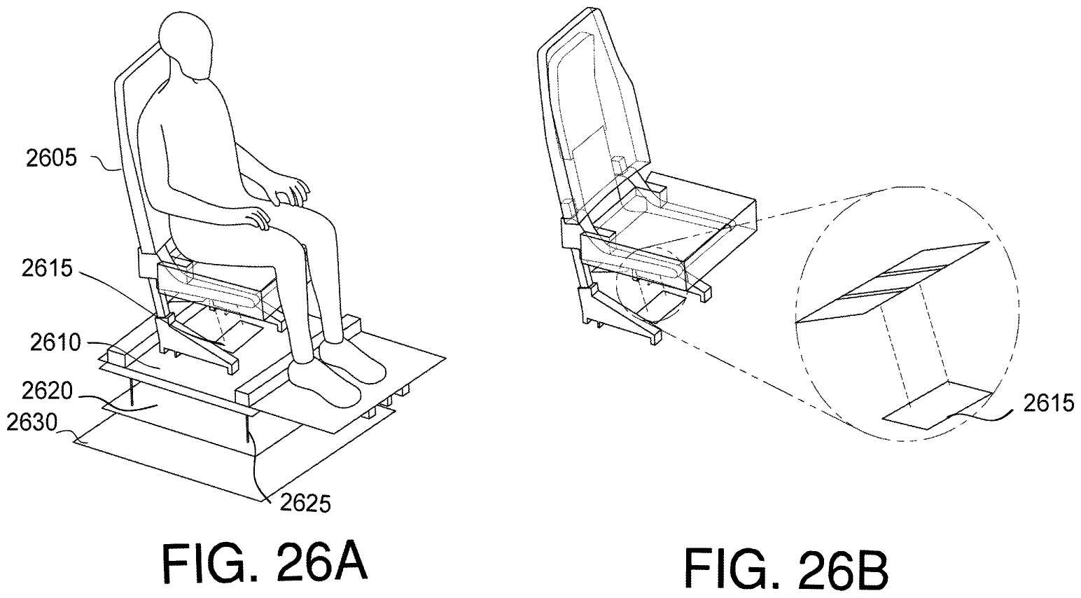

FIGS. 26A and 26B illustrate another exemplary implementation of how the vibration dampening material may be integrated into a vehicle to dissipate vibrations. In an embodiment, the vibration dampening material may be an energy absorber component that is installed between a vehicle seat and a vehicle floor. For instance, FIG. 26A illustrates a seat bucket 2605, a vehicle floor 2610, an energy absorber component 2615, a vehicle subfloor 2620, subfloor energy absorber components 2625, and a vehicle skin 2630. Energy absorber component 2610 may be attached to, or integrated with, a portion of vehicle floor 2610 positioned directly below seat bucket 2605, as further illustrated in FIG. 26B. During vehicle operation, vibrations that are conventionally felt by a seated passenger are absorbed by energy absorber component 2615. In some embodiments, subfloor energy absorber components 2625 positioned between a vehicle subfloor 2620 and vehicle floor 2610 may also be utilized to further increase vibration dampening.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A vehicle seat, comprising:
a seat leg having a base component and a rod component, wherein a first surface of the base component is attached to a floor of a vehicle and a second surface of the base component is attached to a first end of the rod component;
an energy absorbing component associated with the rod component; and
a seat bucket having a receiving component configured to house the energy absorbing component and the rod component.

2. The vehicle seat of claim 1, wherein the energy absorbing component is a foam component positioned against a second end of the rod component and wherein the energy absorbing component is configured to be compressed by the rod component upon experiencing a predetermined force load.

3. The vehicle seat of claim 1, wherein the energy absorbing component is a tube, fixed within the receiving component, comprising a plurality of progressively tapered fins on an interior surface thereof;
wherein a portion of the rod component is positioned within an interior cavity formed by the plurality of progressively tapered fins, and wherein the tube is configured to travel down a length of the rod component upon experiencing a predetermined force load; and
wherein an outer surface of the rod component is delaminated as a result of contact against at least a subset of the progressively tapered fins during the travel.

4. The vehicle seat of claim 1, wherein the energy absorbing component is a tube, fixed within the receiving component, that comprises a chisel positioned within a notched groove on an outer surface of the rod component;
wherein the rod component is positioned through an interior cavity of the tube;
wherein the tube is configured to travel down a length of the rod component upon experiencing a predetermined force load;
and wherein a portion of the outer surface of the rod component is delaminated by the chisel during the travel.

5. The vehicle seat of claim 1, wherein the energy absorbing component is a compression die, fixed within the receiving component, that comprises a tapered interior cavity;
wherein a portion of the rod component is positioned within the tapered interior cavity;
wherein the compression die is configured to travel down a length of the rod component upon experiencing a predetermined force load; and
wherein a diameter of the rod component is reduced by contact with the tapered interior cavity during the travel.

6. The vehicle seat of claim 1, wherein the energy absorbing component is a shape-changing die, fixed within the receiving component, that comprises a first shape for a first opening and a second shape for a second opening;
wherein a first end of the rod component is positioned within an interior cavity of the shape-changing die via insertion through the first opening having the first shape;
wherein the shape-changing die is configured to travel down a length of the rod component upon experiencing a predetermined force load; and
wherein portions of the rod component exiting the second opening are transformed to have the second shape.

7. The vehicle seat of claim 1, wherein the energy absorbing component is a stepped die, fixed within the receiving component, that comprises a plurality of ridges and an interior cavity;
wherein the stepped die is configured to travel down a length of the rod component upon experiencing a predetermined force load; and
wherein a diameter of the rod component is reduced at each of the plurality of ridges during the travel.

8. The vehicle seat of claim 1, wherein the energy absorbing component is an expansion die that is fixed within the receiving component;
wherein the expansion die includes a first portion with a first diameter and a second portion with a second diameter;
wherein the expansion die is configured to travel down a distance of an interior cavity of the rod component upon experiencing a predetermined force load, wherein the distance is based on a length of the first portion; and
wherein the interior cavity of the rod component is configured to expand around the expansion die during the travel.

9. The vehicle seat of claim 8, wherein the rod component has a ridged and grooved exterior shape;
wherein the grooved exterior shape is configured to be transformed to a second shape during the travel.

10. The vehicle seat of claim 1, wherein the energy absorbing component is a portion of the rod component.

11. The vehicle seat of claim 10, wherein the portion is a machined cutout pattern that is configured to expand upon experiencing a predetermined force load.

12. The vehicle seat of claim 10, wherein the portion is a machined cutout pattern that is configured to be crushed upon experiencing a predetermined force load.

13. An energy absorbing seat of a vehicle, comprising:
a seat leg having a base component and a rod component, wherein a first surface of the base component is attached to a floor of the vehicle and a second surface of the base component is attached to a first end of the rod component; and
a seat bucket attached onto the second end of the rod component of the seat leg, wherein the seat bucket comprises a first component and a second component;
wherein the first component comprises a folded area secured by one or more stitches;
wherein the folded area is configured to rip upon experiencing a predetermined force load.

14. The energy absorbing seat of claim 13, wherein the first component is a textile fabric.

15. The energy absorbing seat of claim 14, wherein a layer of the textile fabric is folded within the folded area.

16. The energy absorbing seat of claim 13, wherein the folded area comprises a plurality of folded areas and wherein each of the plurality of folded areas comprises a unique stitching pattern.

17. The energy absorbing seat of claim 13, further comprising an energy absorbing mechanism positioned within a receiving component of the seat bucket.

18. A method of decreasing a force of an impact event on a user in a vehicle seat of a vehicle, the method comprising:
receiving, at a first component of the vehicle seat, a predetermined force load associated with the impact event, wherein the first component is a textile fabric comprising a folded area secured by one or more stitches;
ripping, in response to the received predetermined force load, the one or more stitches of the folded area;
freeing, responsive to the ripping, an additional portion of the textile fabric contained within the folded area; and
lowering, based on the freeing, the first component a predetermined distance as dictated by the additional portion.

19. The method of claim 18, wherein the folded area comprises a predetermined stitching pattern comprising a predetermined number of the one or more stitches.

20. The method of claim 18, wherein the vehicle seat comprises an energy absorbing mechanism positioned within a receiving component of vehicle seat and further comprising:
lowering the vehicle seat by an additional amount based on characteristics of the energy absorbing mechanism.
